(19) United States
(12) Patent Application Publication
(10) Pub. No.: US 2010/0027506 A1
(43) Pub. Date: Feb. 4, 2010

(54) WIRELESS COMMUNICATION SYSTEM, WIRELESS COMMUNICATION TERMINAL AND CELL STATION, AND WIRELESS COMMUNICATION METHOD

(75) Inventors: Hironobu Tanigawa, Tokyo (JP); Yasuhiro Nakamura, Yokohama-shi (JP); Nobuaki Takamatsu, Yokohama-shi (JP)

Correspondence Address: MORRISON & FOERSTER LLP, 12531 HIGH BLUFF DRIVE, SUITE 100, SAN DIEGO, CA, 92130-2040, US

(73) Assignee: Kyocera Corporation

(21) Appl. No.: 12/443,172

(22) PCT Filed: Sep. 21, 2007
(86) PCT No.: PCT/JP2007/068443

§ 371 Date: Mar. 26, 2009

(30) Foreign Application Priority Data
Sep. 28, 2006 (JP) 2006 263886

(51) Int. Cl. H04W 36/00

(52) U.S. Cl. 370/331

(57) ABSTRACT

The present invention relates to a wireless communication system for TDMA communication with use of one or more communication channels among at least one of a plurality of cell stations and a wireless communication terminal. The wireless communication terminal includes a link-channel-allocation requesting unit that transmits a link-channel allocation request signal upon handover without specifying a destination cell station, using a handover control channel included in the communication channels which is used for transmitting control information concerning handover and has a unique channel number in the wireless communication system. The one of the cell stations includes a link-channel allocating unit that transmits, to the wireless communication terminal, a link-channel allocation signal including link-channel allocation information using the handover control channel upon receiving the link-channel allocation request signal.

### TECHNICAL FIELD

The present invention relates to a wireless communication system, a wireless communication terminal and a cell station, and a wireless communication method.

Priority is claimed on Japanese Patent Application No. 2006-263886, filed Sep. 28, 2006, the content of which is incorporated herein by reference.

### BACKGROUND ART

FIG. 6 is a sequence chart illustrating a signal processing procedure for a cell station, a wireless communication terminal, and a network upon handover of a conventional PHS (Personal Handyphone System).

Upon detecting deterioration in a traffic channel (TCH) (deterioration in channel quality) during communication with a cell station (handover-source cell station) CS1, a wireless communication terminal (hereinafter, “personal station PS”) transmits a handover request (TCH change request) signal to the handover-source cell station CS 1 (step S20). Upon receiving the handover request signal from the personal station PS, the handover-source cell station CS1 transmits a TCH-change instruction signal indicating that handover is available to the personal station PS (step S21).

Upon receiving the TCH-change instruction signal from the handover-source cell station CS1, the personal station PS searches downlink signals transmitted from neighboring cell stations by open search, and determines a cell station from which a signal which is one of captured downlink signals and corresponds to the greatest reception power is received as a handover-destination cell station CS2 (step S22). Then, the personal station PS transmits an LCH (link channel)-establishment request channel to the handover-destination cell station CS2 (step S23). The link channel is a designation of a channel to be used for the cell station CS1 and the personal station PS to connect each other upon commencement of communication or for the personal station PS and the destination cell station CS2 to connect each other upon handover.

Upon receiving the LCH-establishment request signal, the handover-destination cell station CS2 transmits an LCH allocation signal including TCH allocation information if TCH can be allocated to the personal station PS (step S24), and activates the TCH allocated to the personal station PS (step S25).

Upon receiving the LCH allocation signal from the handover-destination cell station CS2, the personal station PS performs a call setting to the handover-destination cell station CS2 (step S26), and the handover-destination cell station CS2 also performs a call setting to the network (step S27). The network connects to the handover-destination cell station CS2 (step S28), instructs the handover-source cell station CS1 to disconnect from the personal station PS (step S29), and further disconnects from the handover-source cell station CS1 (step S30).

Then, the handover-source cell station CS1 disconnects the wireless channel to the personal station PS (step S31). The personal station PS disconnects from the handover-source cell station CS1 (step S32), changes the channel to the TCH allocated by the handover-destination cell station CS2, and commences communication with the handover-destination cell station CS2 (step S33).

See the following Patent Documents 1 to 4 for the details of these handover technologies.

[Patent Document I] Japanese Unexamined Patent Application, Fast Publication No. 2000-312371

[Patent Document 2] Japanese Unexamined Patent Application, Fast Publication No. H08-154269

[Patent Document 3] Japanese Unexamined Patent Application, Fast Publication No. 2000-308108

[Patent Document 4] Japanese Unexamined Patent Application, Fast Publication No. 2001-54154

### DISCLOSURE OF THE INVENTION

### Problems to be Solved by the Invention

In the conventional PHS, autonomous distributed control is performed so that the same channel is not used by multiple cell stations, thereby achieving recycling of radio resources and a reduction in radio wave interference. Accordingly, precise synchronization control between cell stations and between a cell station and a terminal is required. However, there is a merit in that cell design is unnecessary, thereby enabling easy expansion of a system, and the like.

In the conventional PHS, a control channel (CCH) is shared by all cell stations and all personal stations, causing a problem in that a period of timing in which one cell station can use CCH by the autonomous distributed control is very long (approximately 100 ms). In other words, when LCH is allocated upon handover as shown in FIG. 6, the personal station PS transmits the LCH-establishment request signal to the handover-destination cell station CS2 through the uplink CCH at step S23. However, the handover-destination cell station CS2 has to wait for the next timing of using CCH (downlink CCH) (approximately 100 mm after) to transmit a response (LCH allocation signal) to the personal station PS.

Further, upon the open search at step S22 shown in FIG. 6, there are many neighboring cell stations targeted for the search. Accordingly, it takes time (approximately 100 ms) to capture downlink signals transmitted from respective cell stations, and it also takes time for CPU to calculate the reception power of the signals, thereby causing a long total processing time for open search. Therefore, a long processing time (approximately 300 ms) from steps S22 to S24 shown in FIG. 6 has been required for the conventional handover. Further, the channel quality between the personal station and the cell station is deteriorated upon handover. Accordingly, retransmission of the signal occurs in some cases, thereby causing a longer processing time by the time of the retransmission. If the maximum retransmission number of times is set to three, for example, delay for up-to 300 ms occurs only for the retransmission (it takes a longer time since a retransmission timer has to be timed out in reality). Thus, it has taken a very long time for handover in the conventional PHS.

The present invention is made in consideration of the situations, and an object thereof is to achieve a fast handover.

### Means for Solving the Problems

To achieve the object, a first embodiment of the present invention is a wireless communication system for TDMA communication with use of one or more communication channels among at least one of a plurality of cell stations and a wireless communication terminal. The wireless communication terminal includes a link-channel-allocation requesting unit that transmits a link-channel allocation request signal upon handover without specifying a destination cell station, using a handover control channel included in the communication channels, the handover control channel being used for transmitting control information concerning handover and having a unique channel number in the wireless communication system. The one of the cell stations includes a link-channel allocating unit that transmits, to the wireless communication terminal, a link-channel allocation signal including link-channel allocation information using the handover control channel upon receiving the link-channel allocation request signal.

In the first embodiment, the one of the cell stations may include a channel determining unit that determines a downlink handover control channel of the handover control channel so that a transmission timing of the link-channel allocation signal differs from that of another cell station that has received the link-channel allocation request signal. The link-channel allocating unit may transmit the link-channel allocation signal to the wireless communication terminal using the downlink handover control channel determined by the channel determining unit.

In the second embodiment, the wireless communication terminal may include an obtaining unit that obtains number information concerning the number of neighboring cell stations during a period in which the wireless communication terminal is not in communication. The link-channel-allocation requesting unit may transmit a link-channel allocation request signal including the number information obtained by the obtaining unit. The channel determining unit may determine the downlink handover control channel by a random number calculation based on the number information.

In the first embodiment, the wireless communication terminal may include: a reception-power calculating unit that calculates the reception power of a link-channel allocation signal transmitted from each cell station that has received the link-channel allocation request signal; and a handover-destination-cell-station indicating unit that determines a cell station that has transmitted a link-channel allocation signal corresponding to the greatest reception power as a handover-destination cell station, and transmits determination information concerning the handover-destination cell station to the cell station that has received the link-channel allocation request signal using an uplink handover control channel. The cell station may include a link-channel activating unit that activates a link channel allocated to the wireless communication terminal upon determining that the cell station is the handover-destination cell station based on the determination information concerning the handover-destination cell station.

In the first embodiment, the communication channels may be subchannels to be used for OFDMA in which a frequency band to be used for communication is divided into a plurality of subchannels each including a plurality of subcarriers.

In the fifth embodiment, the link-channel allocating unit allocates any one of subchannels to be used for traffic channels as a dedicated control channel dedicated for the wireless communication terminal, and transmits a link-channel allocation signal including allocation information concerning the dedicated control channel.

A second embodiment of the present invention is a wireless communication terminal that performs TDMA communication with a plurality of cell stations using one or more communication channels. The wireless communication terminal includes a link-channel allocation requesting unit that transmits a link-channel allocation request signal upon handover without specifying a destination cell station, using a handover control channel included in the communication channels. The handover control channel is used for transmitting control information concerning handover and has a unique channel number in the wireless communication system.

In the second embodiment, the wireless communication terminal may include an obtaining unit that obtains number information concerning the number of neighboring cell stations during a period in which the wireless communication terminal is not in communication. The link-channel-allocation requesting unit may transmit a link-channel allocation request signal including the number information obtained by the obtaining unit.

In the second embodiment, the wireless communication terminal may include: a reception-power calculating unit that calculates the reception power of a link-channel allocation signal transmitted from each cell station that has received the link-channel allocation request signal; and a handover-destination-cell-station indicating unit that determines a cell station that has transmitted a link-channel allocation signal corresponding to the greatest reception power as a handover-destination cell station, and transmits determination information concerning the handover-destination cell station to the cell station that has received the link-channel allocation request signal using an uplink handover control channel.

In the second embodiment, the communication channels may be subchannels to be used for OFDMA in which a frequency band to be used for communication is divided into a plurality of subchannels each including a plurality of subcarriers.

A third embodiment of the present invention is a cell station that performs TDMA communication with a wireless communication terminal using one or more communication channels. The cell station includes a link-channel allocating unit that transmits, to the wireless communication terminal, a link-channel allocation signal including link-channel allocation information using a handover control channel upon receiving a link-channel allocation request signal from the wireless communication terminal through the handover control channel. The handover control channel is included in the communication channels, used for transmitting control information concerning handover, and has a unique channel number in a wireless communication system.

In the third embodiment, the cell station may include a channel determining unit that determines a downlink handover control channel so that a transmission timing of the link-channel allocation signal differs from that of another cell station that has received the link-channel allocation request signal. The link-channel allocating unit may transmit the link-channel allocation signal to the wireless communication terminal using the downlink handover control channel determined by the channel determining unit.

In the third embodiment, the channel determining unit may determine the downlink handover control channel by a random number calculation based on number information concerning the number of neighboring stations which is transmitted from the wireless communication terminal.

In the third embodiment, the cell station may include a link-channel activating unit that activates a link channel allocated to the wireless communication terminal upon determining that the cell station is a handover-destination cell station based on determination information concerning the handover-destination cell station which is transmitted from the wireless communication terminal.

In the third embodiment, the communication channels may be subchannels to be used for OFDMA in which a frequency band to be used for communication is divided into a plurality of subchannels each including a plurality of subcarriers.

In the third embodiment, the link-channel allocating unit may allocate any one of subchannels to be used for traffic channels as a dedicated control channel dedicated for the wireless communication terminal, and transmit a link-channel allocation signal including allocation information concerning the dedicated control channel.

A fourth embodiment of the present invention is a method for TDMA wireless communication with use of one or more communication channels among at least one of a plurality of cell stations and a wireless communication terminal. The method may include: a link-channel-allocation requesting step of the wireless communication terminal transmitting a link-channel allocation request signal upon handover without specifying a destination cell station, using a handover control channel which is included in the communication channels, used for transmitting control information concerning handover, and has a unique channel number in a wireless communication system; and a link-channel allocating step of the one of the cell stations transmitting, to the wireless communication terminal, a link-channel allocation signal including link-channel allocation information using the handover control channel upon receiving the link-channel allocation request signal.

Among slots to be used as traffic channels of the communication channels, slots to be used as handover control channels which are used for transmitting and receiving control information concerning handover and have a unique slot number in the wireless communication system, are preliminarily defined in the present invention. In other words, the handover control channel can be used with a period of one frame (approximately 5 ms) similarly to the traffic channels, thereby enabling fast transmission and reception of control information concerning handover between the cell station and the wireless communication terminal. Additionally, in the present invention, the wireless communication terminal transmits a link-channel-allocation request signal using an uplink handover control channel without specifying a transmission-destination cell station. Upon receiving the link-channel-allocation request signal, the cell station transmits a link-channel allocation signal including link-channel allocation information to the wireless communication terminal using a downlink handover control channel. Thereby, time-consuming processing such as the conventional open search is unnecessary.

### EFFECTS OF THE INVENTION

According to the present invention, fast handover can be achieved.

### BRIEF DESCRIPTION OF THE DRAWINGS

FIG. 1 schematically illustrates the configuration of a wireless communication system according to an embodiment of the present invention.

FIG. 2 schematically illustrates a relationship among frequencies, slots, and subchannels of the wireless communication system according to the embodiment of the present invention.

FIG. 3 is a block diagram illustrating the configurations of a cell station CS and a wireless communication terminal PS according to the embodiment of the present invention.

FIG. 4 illustrates the detail of a wireless communication unit 2 according to the embodiment of the present invention.

FIG. 5 is a sequence chart of the wireless communication system according to the embodiment of the present invention upon handover.

FIG. 6 is a sequence chart of a conventional PHS upon handover.

### DESCRIPTION OF REFERENCE SYMBOLS

CS, CS1, CS2, CS3, and CS4 cell station
PS wireless communication terminal (personal station)
1 and 10 controller
2 and 11 wireless communication unit
3 and 14 storing unit
1a subchannel determining unit
1b link-channel allocating unit
1c link-channel activating unit
12 operation unit
13 display unit
10a cell-station information obtaining unit
10b link-channel-allocation requesting unit
10c reception-power calculating unit
10d handover-destination-cell-station indicating unit

### BEST MODE FOR CARRYING OUT THE INVENTION

Hereinafter, an embodiment of the present invention is explained in detail with reference to the accompanying drawings. The present invention is not limited to the following embodiment. For example, elements of the embodiment may appropriately be combined.

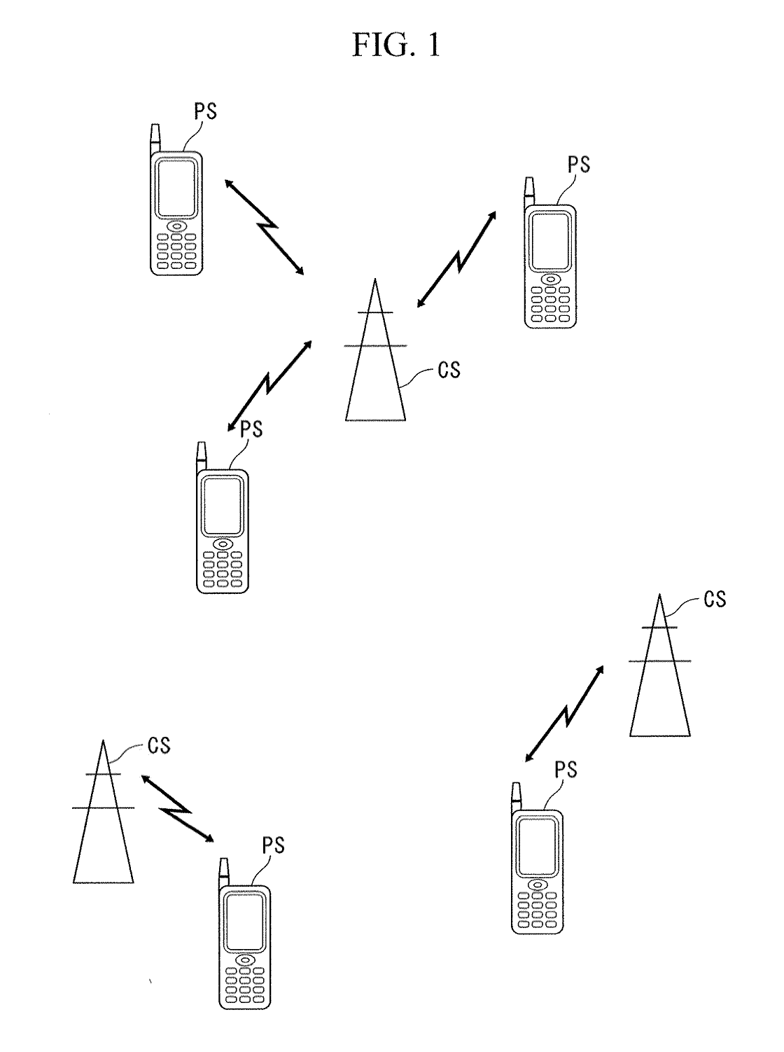

As shown in FIG. 1, a wireless communication system according to an embodiment of the present invention includes a cell station CS, a wireless communication terminal (hereinafter, “personal station”) PS, and a non-depicted network. The cell station CS and the personal station PS communicate each other using orthogonal frequency division multiple access (OFDMA) in addition to time division multiple access (TDMA) and time division duplexing (TDD) as multiple access schemes. Multiple cell stations CS are provided at a given interval and wirelessly communicate with multiple personal stations PS by the multiple accesses. The personal station PS requests handover to another cell station device upon detecting deterioration in channel quality.

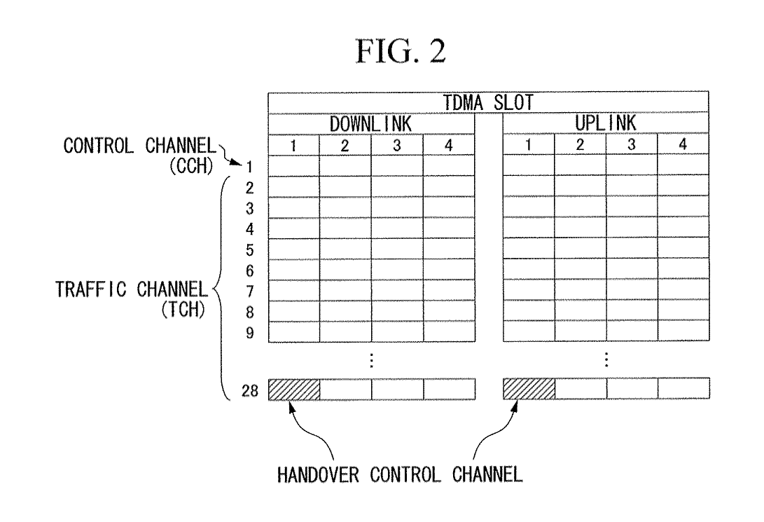

As well known, OFDMA is a technology in which all of orthogonal subcarriers are shared by all of the personal stations PS, any number of subcarriers is grouped, and each personal station PS is appropriately allocated one or more groups of subcarriers, thereby achieving multiple accesses. In the wireless communication system of the present embodiment, TDMA and TDD are combined with OFDMA. In other words, each group is divided into uplink and downlink in a time-axis direction as TDD. Further, each of the uplink and the downlink is divided into four TDMA slots. In the present embodiment, each of units formed by each group being divided into TDMA slots in the time-axis direction is called a subchannel. FIG. 2 illustrates a relationship among frequencies, TDMA slots, and subchannels in the wireless communication system of the present embodiment. The vertical and horizontal axes represent frequency and time, respectively. As shown in FIG. 2, the total number of 112 subchannels defined by 28 subcarriers in the frequency-axis direction multiplied by 4 slots in the time-axis direction is allocated to each of the uplink and the downlink.

As shown in FIG. 2, the endmost subchannel in the frequency direction (first subchannel in the case of FIG. 2) among all subchannels is used as a control channel (CCH), and the rest of the subchannels are used as traffic channels (TCH) in the wireless communication system of the present embodiment. Hereinafter, these traffic channels are called traffic subchannels. Any one or more traffic subchannels are allocated to the cell station CS and the personal station PS that communicate each other from among all the traffic subchannels (27×4 slots=108 subchannels in total excluding CCH in this case) belonging to each of uplink and downlink. The same traffic channels are allocated to the uplink and downlink traffic subchannels as communication channels.

In the wireless communication system of the present embodiment, handover control channels of the traffic subchannels, which are used for transmitting and receiving control information concerning handover and have a unique number in the wireless communication system, are preliminarily defined. In the wireless communication system, for example, the 28th traffic subchannels belonging to the “1st” slots of the uplink and the downlink are defined as the handover control channels, as shown in FIG. 2.

In the wireless communication system, CCH is shared by all of the cell stations and the personal stations similarly to the conventional PHS, and a timing period for which one cell station CS can use CCH is very long (approximately 100 ms). However, the handover control channel of the present embodiment is defined among the traffic subchannels. Therefore, the cell station CS can use the handover control channel with a period of one frame (5 ms).

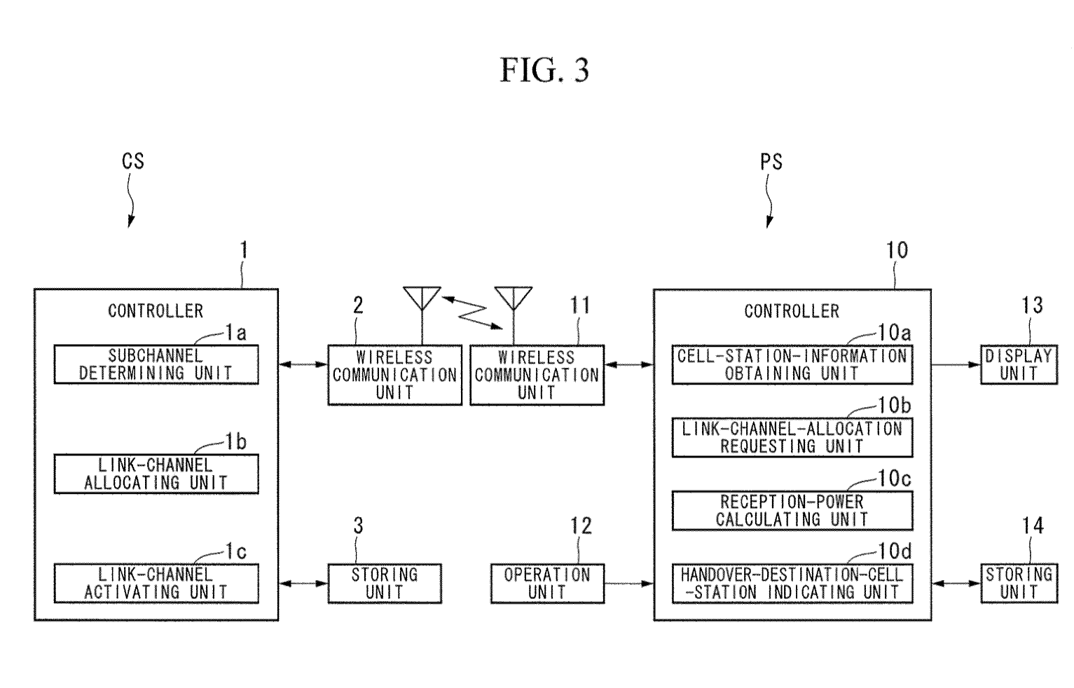

FIG. 3 is a block diagram illustrating the configuration of main units of the cell station CS and the personal station PS according to the present embodiment. As shown in FIG. 3, the cell station CS includes a controller 1, a wireless communication unit 2, and a storing unit 3. The controller 1 includes a subchannel determining unit 1a, a link-channel allocating unit 1b, and a link-channel activating unit 1c, as characteristic functional units of the present embodiment. The cell station CS is connected to a non-depicted network, and can communicate with another cell station, a server connected to the network, or the like through the network.

In the cell station CS, the controller 1 controls the overall operations of the cell station CS based on cell-station control programs stored in the storing unit 3, reception signals received through the wireless communication unit 2, and external signals received through the network.

In the controller 1, the subchannel determining unit 1a determines a subchannel to be used as the downlink handover control channel so that the transmission timing of a link-channel allocation request signal that will be explained later differs from that of another cell station that receives the link-channel allocation request signal from the personal station PS. Specifically, the subchannel determining unit 1a determines a subchannel to be used as the downlink handover control channel by a random number calculation based on information concerning the number of neighboring cell stations which is transmitted from the personal station PS. The detail of the method of determining the subchannel to be used as the downlink handover control channel is explained later.

Upon receiving a link-channel allocation request signal from the personal station PS through an uplink handover control channel, the link-channel allocating unit 1b transmits a link-channel allocation signal including link-channel allocation information to the personal station PS using the subchannel determined as the downlink handover control channel by the subchannel determining unit 1a. The link-channel allocating unit 1b allocates any one of subchannels to be used as traffic subchannels as a dedicated control channel dedicated for the personal station PS, and transmits a link-channel allocation signal including allocation information concerning the dedicated control channel to the personal station PS.

The dedicated control channel is called an anchor subchannel in the present embodiment. The anchor subchannel is a control channel to be used for transmitting and receiving allocation information concerning traffic subchannels to be used for data communication (hereinafter “extra subchannels”) between the cell station CS and the personal station PS. The anchor subchannel is allocated from among the traffic subchannels, and therefore can be used with a period of one frame (5 ms) similarly to the handover control channel.

The link-channel activating unit 1c actives the link channel (anchor subchannel) allocated by the link-channel allocating unit 1b to the personal station PS when the cell station CS determines that the cell station CS is a handover-destination cell station based on determination information concerning the handover-destination cell station transmitted from the personal station PS.

Under control of the controller 1, the wireless communication unit 2 performs error correction coding, modulation, and OFDM multiplexing on a control signal (such as a link-channel allocation signal) or a data signal output from the controller 1, converts the multiplexed signal (OFDM signal) into a radio frequency signal, and transmits the radio frequency signal to the personal station PS as a transmission signal.

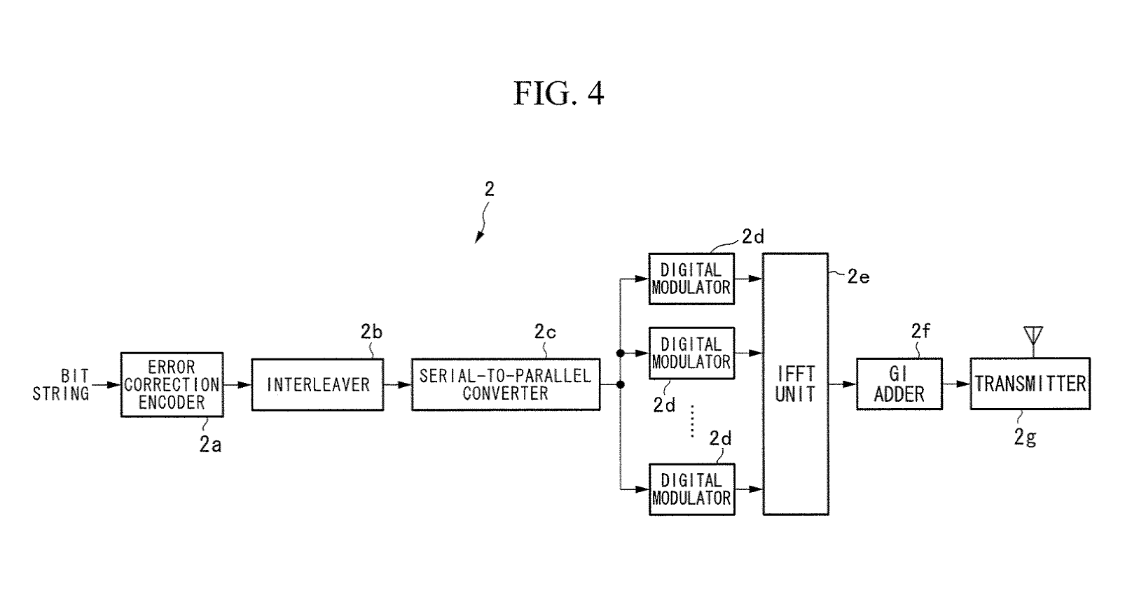

More specifically, the wireless communication unit 2 on the transmitting side includes an error correction encoder 2a, an interleaver 2b, a serial-to-parallel converter 2c, a digital converter 2d, an IFFT (Inverse Fast Fourier Transform) unit 2e, a GI (Guard Interval) adder 2f, and a transmitter 2g, as shown in FIG. 4.

The error correction encoder 2a is, for example, an FEC (Forward Error Correction) encoder, adds an error correction code that is redundant information to a bit string of a control signal or a data signal input from the controller 1 based on an encoding rate indicated by the controller 1, and outputs the bit string to the interleaver 2b. The interleaver 2b interleaves the bit sting to which the error correction code has been added by the error correction encoder 2a. The serial-to-parallel converter 2c divides the interleaved bit string bit by bit for subcarriers included in the subchannel indicated by the controller 1, and outputs the bit data to the digital modulators 2d.

The digital modulators 2d, the number of which correspond to that of the subcarriers, digitally modulate the bit data divided for respective subcarriers using the respective subcarriers corresponding to the bit data, and output the modulated signals to the IFFT unit 2e. Each digital modulator 2d performs digital modulation based on a modulation scheme indicated by the controller 1, such as BPSK (Binary Phase Shift Keying), QPSK (Quadrature Phase Shift Keying), 16 QAM (Quadrature Amplitude Modulation), or 64 QAM.

The IFFT unit 2e generates an OFDM signal by performing IFFT and orthogonal multiplexing on the modulated signals input from the respective digital modulators 2d, and outputs the OFDM signal to the GI adder 2f. The GI adder 2f adds a guard interval (GI) to the OFDM signal input from the IFFT unit 2e and outputs the resultant signal to the transmitter 2g. The transmitter 2g converts the OFDM signal input from the GI adder 2f into a radio frequency signal and transmits the converted signal to the personal station PS as a transmission signal.

On the other hand, the wireless communication unit 2 on the receiving side, although not shown, includes units that perform the reverse of the operations performed on the transmitting side. In other words, the wireless communication unit 2 on the receiving side converts a reception signal received from the personal station PS into an intermediate frequency signal to extract the received OFDM signal, removes the guard interval from the received OFDM signal, restores the bit string by performing FFT, digital demodulation, parallel-to-serial conversion, deinterleaving, and error correction decoding, and outputs the bit string to the controller 1.

With reference to FIG. 3, the storing unit 3 stores the cell-station control programs or other data to be used by the controller 1, and functions as a buffer to be used for flow control or retransmission control.

Hereinafter, the configuration of the personal station PS is explained. As shown in FIG. 3, the personal station PS includes a controller 10, a wireless communication unit 11, an operation unit 12, a display unit 13, and a storing unit 14. The controller 10 includes a cell-station-information obtaining unit 10a, a link-channel-allocation requesting unit 10b, a reception-power calculating unit 10c, and a handover-destination-cell-station indicating unit 10d, as characteristic functional units of the present embodiment.

In the personal station PS, the controller 10 controls the overall operations of the personal station PS based on personal-station control programs stored in the storing unit 14, reception signals received through the wireless communication unit 11, or an operation signal input from the operation unit 12.

In the controller 10, the cell-station-information obtaining unit 10a controls the wireless communication unit 11 to search control signals, such as broadcast signals, transmitted from neighboring cell stations during a period in which the personal station PS is not in communication with the cell station CS (for example, in an idle state), and thereby obtains information concerning the number of the neighboring cell stations. Upon handover, the link-channel-allocation requesting unit 10b transmits a link-channel-allocation request signal using an uplink handover control channel without specifying a transmission-destination cell station. The link-channel-allocation request signal includes the information concerning the number of the neighboring cell stations.

The reception-power calculating unit 10c calculates the reception power of a link-channel allocation signal transmitted from each cell station that has received the link-channel-allocation request signal. Based on the result of the calculation of the reception power of the link-channel allocation signal performed by the reception-power calculating unit 10c, the handover-destination-cell-station indicating unit 10d determines a cell station CS that has transmitted the link-channel allocation signal corresponding to the greatest reception power as a handover-destination cell station. Then, the handover-destination-cell-station indicating unit 10d transmits determination information concerning the handover-destination cell station (specifically, an ID of the handover-destination cell station) to each cell station (cell station that has transmitted a link-channel allocation signal) using the uplink handover control channel.

Under control of the controller 10, the wireless communication unit 11 performs error correction coding, modulation, and OFDM multiplexing on a control signal (such as link-channel-allocation request signal or determination information concerning the handover-destination cell station) or a data signal output from the controller 10, converts the multiplexed signal (OFDM signal) into a radio frequency signal, and transmits the radio frequency signal to the cell station CS as a transmission signal. A subchannel, a modulation scheme, and a coding rate that are used by the wireless communication unit 11 are allocated by the cell station CS. The configurations of the wireless communication unit 11 on the transmitting and receiving sides are similar to those of the wireless communication unit 2, and therefore explanations thereof are omitted.

The operation unit 12 includes operation keys, such as a power key, various function keys, and numeric keypads, and outputs an operation signal based on an input by the operation keys to the controller 10. The display unit 13 includes, for example, a liquid crystal display or an organic EL display, and displays images and characters based on a display signal input from the controller 10. The storing unit 14 stores personal-station control programs or various data to be used by the controller 10, and functions as a buffer to be used for retransmission control or the like.

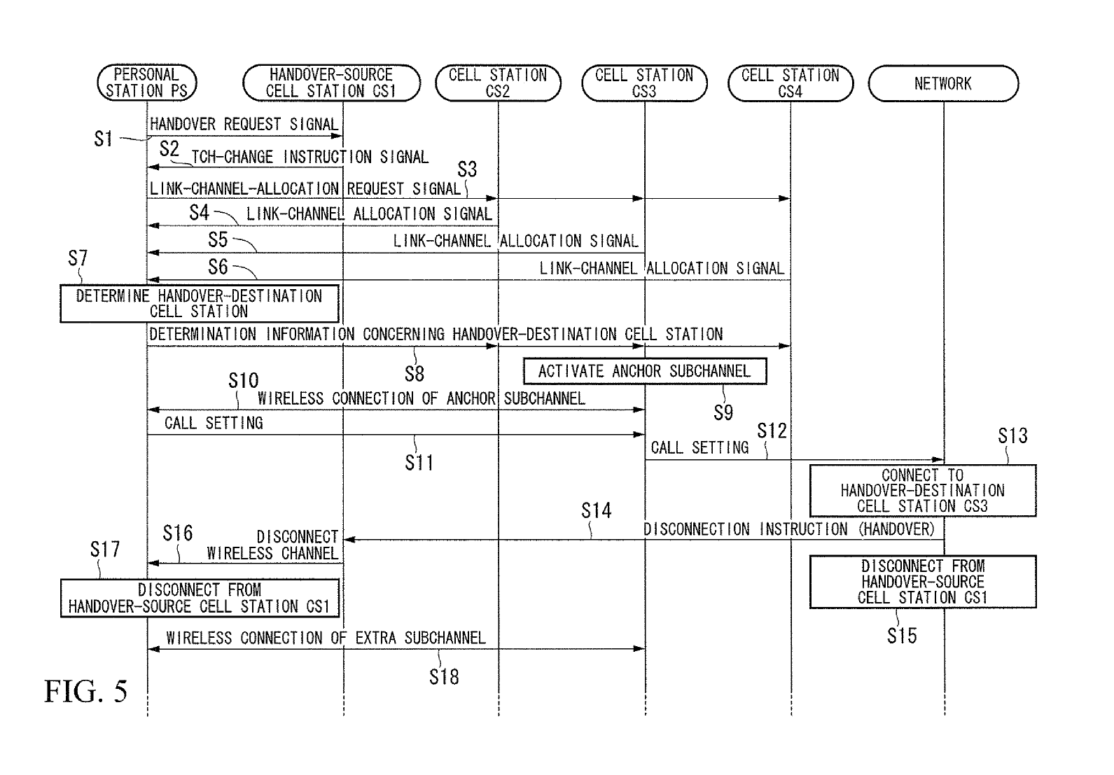

Hereinafter, operations of the cell stations CS and the personal station PS upon handover in the wireless communication system configured as above are explained with reference to a sequence chart shown in FIG. 5. In the following explanations, cell stations CS1 to CS4 have the same configurations as that of the cell station CS.

Although not shown in FIG. 5, the personal station PS (specifically, the cell-station-information obtaining unit 10a) controls the wireless communication unit 11 to search control signals, such as broadcast signals, transmitted from neighboring cell stations during a period in which the personal station PS is not in communication with the cell station (handover-source cell station) CS1 (for example, in the idle state), to obtain information concerning the number of neighboring cell stations, and stores the obtained information in the storing unit 14.

Upon detecting deterioration in the traffic subchannel being used for data communication during communication with the handover-source cell station CS 1, the personal station PS transmits a handover request (TCH change request) signal to the handover-source cell station CS1 (step S1). Upon receiving the handover request signal from the personal station PS, the handover-source cell station CS1 transmits a TCH-change instruction signal indicating that handover is available to the personal station PS (step S2).

Upon receiving the TCH-change instruction signal through the wireless communication unit 11, the link-channel-allocation requesting unit 10b of the personal station PS transmits a link-channel-allocation request signal using the uplink handover control channel without specifying a transmission-destination cell station (specifically, an ID of a transmission-destination cell station). The link-channel-allocation requesting unit 10b obtains the information concerning the number of neighboring cell stations from the storing unit 14, and transmits a link-channel allocation request signal including the obtained information (step S3).

The neighboring cell stations always monitor the uplink handover control channel. It is assumed that three neighboring cell stations CS2 to CS4 receive the link-channel-allocation request signal transmitted from the personal station PS.

The subchannel determining unit 1a of each of the cell stations CS2 to CS4 determines a subchannel to be used as the downlink handover control channel by a random number calculation based on the information concerning the number of neighboring cell stations included in the link-channel-allocation request signal received from the personal station PS. Specifically, if the information concerning the number of neighboring cell stations indicates three stations, the subchannel determining unit 1a determines one number randomly from “1” to “3”, and determines the downlink handover control channel included in a frame corresponding to the determined number as a subchannel to be used for transmitting a link-channel allocation signal. In other words, if “2” is determined by a random number calculation, the subchannel determining unit 1a determines the downlink handover control channel included in the second frame counted from when the link-channel-allocation request channel is received as a subchannel to be used for transmitting the link-channel allocation signal.

In the case of FIG. 5, for example, the subchannel determining unit 1a of the cell station CS2 determines the downlink handover control channel included in the first frame counted from when the link-channel-allocation request channel is received as a subchannel to be used for transmitting the link-channel allocation signal. The subchannel determining unit 1a of the cell station CS3 determines the downlink handover control channel included in the second frame counted from when the link-channel-allocation request channel is received as a subchannel to be used for transmitting the link-channel allocation signal. The subchannel determining unit 1a of the cell station CS4 determines the downlink handover control channel included in the third frame counted from when the link-channel-allocation request channel is received as a subchannel to be used for transmitting the link-channel allocation signal.

In other words, the link-channel allocation unit 1b of the cell station CS2 transmits a link-channel allocation signal including an anchor subchannel and the ID of the cell station CS2 to the personal station PS using the downlink handover control channel included in the first frame counted from when the link-channel-allocation request channel is received (step S4). The link-channel allocation unit 1b of the cell station CS3 transmits a link-channel allocation signal including an anchor subchannel and the ID of the cell station CS3 to the personal station PS using a downlink handover control channel included in the second frame counted from when the link-channel-allocation request channel is received (step S5). The link-channel allocation unit 1b of the cell station CS4 transmits a link-channel allocation signal including an anchor subchannel and the ID of the cell station CS4 to the personal station PS using a downlink handover control channel included in the third frame counted from when the link-channel-allocation request channel is received (step S6).

As explained above, interference occurring when the personal station PS receives the link-channel allocation signal can be prevented by changing the transmission timing of the link-channel allocation signals from the cell stations CS2 to CS4. However, the same subchannel might be selected among different cell stations when a subchannel to be used as the downlink handover control channel is determined by a random number (the same number might be calculated by different cell stations because of the mechanical random number calculation). As a solution, for example, the cell stations CS2 to CS4 may randomly transmit the link-channel allocation signals twice at difference timings, respectively.

Then, the reception-power calculating unit 10c of the personal station PS calculates the reception powers of the link-channel allocation signals transmitted from the respective cell stations CS2 to CS4. Then, the handover-destination-cell-station indicating unit 10d of the personal station PS determines, as a handover-destination cell station, the cell station that has transmitted the link-channel allocation signal corresponding to the greatest reception power based on the results of the calculation of the reception powers of the link-channel allocation signals performed by the reception-power calculating unit 10c (step S7). Further, the handover-destination-cell-station indicating unit 10d transmits determination information concerning the handover-destination cell station (specifically, the ID of the handover-destination cell station) to the cell stations CS2 to CS4 (step S8).

It is assumed as an example that the cell station CS3 is determined as the handover-destination cell station. The link-channel activating unit 1c of the cell station CS3 determines that the cell station CS3 is the handover-destination cell station based on the ID of the handover-destination cell station transmitted from the personal station PS. Then, the link-channel activating unit 1c activates the link channel (anchor subchannel) allocated by the link-channel allocating unit 1b to the personal station PS (step S9). The other cell stations CS2 and CS4 respectively determine that the cell stations CS2 and CS4 are not the handover-destination cell station based on the ID of the handover-destination cell station transmitted from the personal station PS, and do not activate the anchor subchannel.

Then, the personal station PS performs wireless connection of the anchor subchannel allocated by the cell station (handover-destination cell station) CS3 (step S10), and then call setting to the handover-destination cell station CS3 (step S11). Further, the handover-destination cell station CS3 performs call setting to the network (step S12). The network connects to the handover-destination cell station CS3 (step S13), instructs the handover-source cell station CS1 to disconnect from the personal station PS (step S14), and further disconnects from the handover-source cell station CS 1 (step S15).

Then, the handover-source cell station CS1 disconnects the wireless channel from the personal station PS (step S16). The personal station PS disconnects from the handover-source cell station CS1 (step S17) and commences communication with the handover-destination cell station CS3 by changing the communication channel to a traffic subchannel (extra subchannel) based on the allocation information concerning the extra subchannel to be used for data communication, which is obtained through the anchor subchannel (step S18).

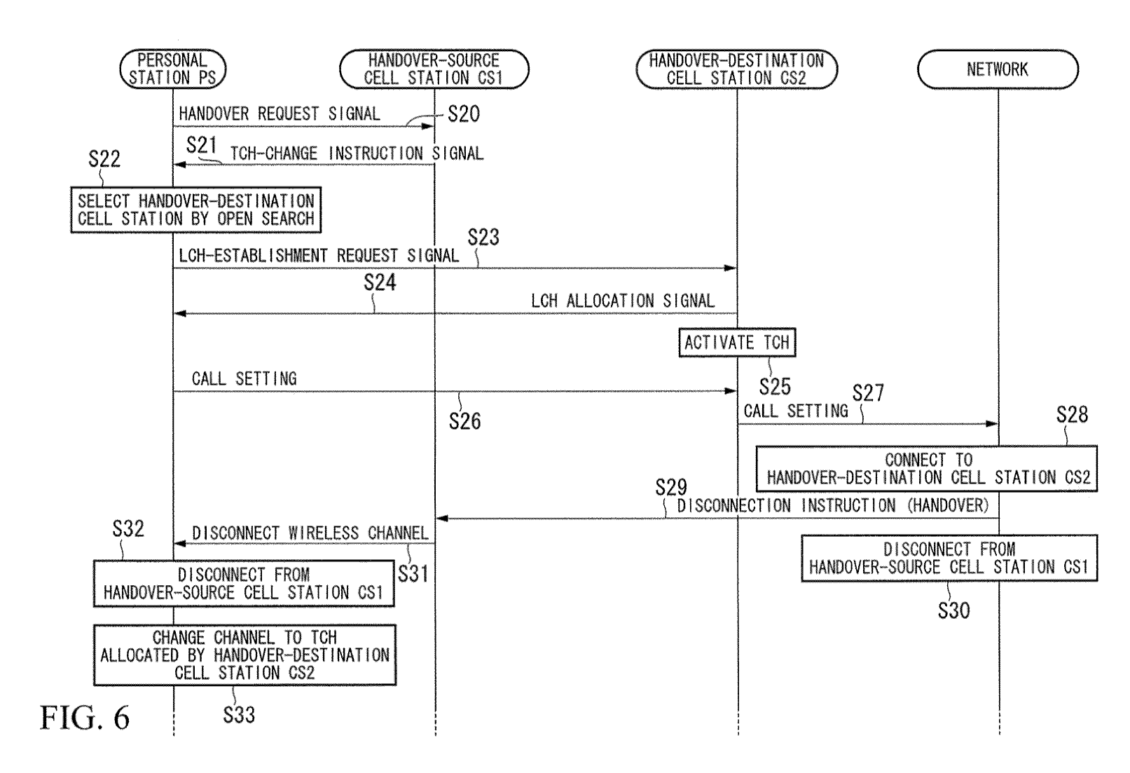

As understood from FIG. 5, the open search at step S22 shown in FIG. 6 in the case of the conventional PHS is unnecessary. Additionally, the handover control channel can be used with a period of one frame (5 ms). Therefore, the shortest processing time from the time of transmission of the link-channel allocation signal at step S3 to the time of transmission of the link-channel allocation signal at step S6 is approximately 5 ms×3 stations=15 ms. Even if it is assumed that there are 10 cell stations that transmit link-channel allocation signals and each cell station transmits the link-channel allocation signal twice because of retransmission, the processing time becomes approximately 5 ms×10 stations×2 times=100 ms at most, thereby achieving much faster handover compared with the case of the conventional PHS.

As explained above, according to the present embodiment, any one of the traffic subchannels is allocated as a dedicated control channel (anchor subchannel) dedicated for the personal station PS, control information (allocation information concerning an extra subchannel) is received and transmitted from and to the handover-destination cell station CS3 through the anchor subchannel with a period of one frame. Thereby, allocation control of radio resources can be performed much faster than the conventional case of using CCH with the long period (approximately 100 ms). As a result, the utilization efficiency of radio resources can be enhanced.

Although the embodiment explains that OFDMA in addition to TDMA and TDD is applied to the wireless communication system as a multiple access technology, the present invention is applicable to a wireless communication system that uses only the conventional TDMA and TDD, not OFDMA. In this case, one slot of traffic channels is fixed as the handover control channel, thereby degrading the utilization efficiency of radio resources. Therefore, it is preferable to use a multicarrier communication scheme such as OFDMA in addition to TDMA and TDD.

Although the allocation information concerning the anchor subchannel is transmitted at steps S4 to S6 shown in FIG. 5 in the embodiment, allocation information concerning traffic channels to be used for data communication as link-channel allocation information may be transmitted at steps S4 to S6 when not a dedicated control channel such as the anchor channel, but a conventional long-period control channel (CCH) is used.

1. A wireless communication system for TDMA communication with use of one or more communication channels among at least one of a plurality of cell stations and a wireless communication terminal,
the wireless communication terminal comprising a link-channel-allocation requesting unit that transmits a link-channel allocation request signal upon handover without specifying a destination cell station, using a handover control channel included in the communication channels, the handover control channel being used for transmitting control information concerning handover and having a unique channel number in the wireless communication system, and
the one of the cell stations comprising a link-channel allocating unit that transmits, to the wireless communication terminal, a link-channel allocation signal including link-channel allocation information using the handover control channel upon receiving the link-channel allocation request signal.

2. The wireless communication system according to claim 1, wherein
the one of the cell stations comprises a channel determining unit that determines a downlink handover control channel of the handover control channel so that a transmission timing of the link-channel allocation signal differs from that of another cell station that has received the link-channel allocation request signal, and
the link-channel allocating unit transmits the link-channel allocation signal to the wireless communication terminal using the downlink handover control channel determined by the channel determining unit.

3. The wireless communication system according to claim 2, wherein:
the wireless communication terminal comprises an obtaining unit that obtains number information concerning the number of neighboring cell stations during a period in which the wireless communication terminal is not in communication;
the link-channel-allocation requesting unit transmits a link-channel allocation request signal including the number information obtained by the obtaining unit; and
the channel determining unit determines the downlink handover control channel by a random number calculation based on the number information.

4. The wireless communication system according to claim 1, wherein the wireless communication terminal comprises
a reception-power calculating unit that calculates the reception power of a link-channel allocation signal transmitted from each cell station that has received the link-channel allocation request signal, and
a handover-destination-cell-station indicating unit that determines a cell station that has transmitted a link-channel allocation signal corresponding to the greatest reception power as a handover-destination cell station, and transmits determination information concerning the handover-destination cell station to the cell station that has received the link-channel allocation request signal using an uplink handover control channel, and the cell station comprises
a link-channel activating unit that activates a link channel allocated to the wireless communication terminal upon determining that the cell station is the handover-destination cell station based on the determination information concerning the handover-destination cell station.

5. The wireless communication system according to claim 1, wherein the communication channels are subchannels to be used for OFDMA in which a frequency band to be used for communication is divided into a plurality of subchannels each including a plurality of subcarriers.

6. The wireless communication system according to claim 5, wherein the link-channel allocating unit allocates any one of subchannels to be used for traffic channels as a dedicated control channel dedicated for the wireless communication terminal, and transmits a link-channel allocation signal including allocation information concerning the dedicated control channel.

7. A wireless communication terminal that performs TDMA communication with a plurality of cell stations using one or more communication channels, comprising
a link-channel allocation requesting unit that transmits a link-channel allocation request signal upon handover without specifying a destination cell station, using a handover control channel included in the communication channels, the handover control channel being used for transmitting control information concerning handover and having a unique channel number in the wireless communication system.

8. The wireless communication terminal according to claim 7, comprising
an obtaining unit that obtains number information concerning the number of neighboring cell stations during a period in which the wireless communication terminal is not in communication, wherein
the link-channel-allocation requesting unit transmits a link-channel allocation request signal including the number information obtained by the obtaining unit.

9. The wireless communication terminal according to claim 7, comprising
a reception-power calculating unit that calculates the reception power of a link-channel allocation signal transmitted from each cell station that has received the link-channel allocation request signal, and
a handover-destination-cell-station indicating unit that determines a cell station that has transmitted a link-channel allocation signal corresponding to the greatest reception power as a handover-destination cell station, and transmits determination information concerning the handover-destination cell station to the cell station that has received the link-channel allocation request signal using an uplink handover control channel.

10. The wireless communication terminal according to claim 7, wherein the communication channels are subchannels to be used for OFDMA in which a frequency band to be used for communication is divided into a plurality of subchannels each including a plurality of subcarriers.

11. A cell station that performs TDMA communication with a wireless communication terminal using one or more communication channels, comprising
a link-channel allocating unit that transmits, to the wireless communication terminal, a link-channel allocation signal including link-channel allocation information using a handover control channel upon receiving a link-channel allocation request signal from the wireless communication terminal through the handover control channel, the handover control channel being included in the communication channels, used for transmitting control information concerning handover, and having a unique channel number in a wireless communication system.

12. The cell station according to claim 11, comprising
a channel determining unit that determines a downlink handover control channel so that a transmission timing of the link-channel allocation signal differs from that of another cell station that has received the link-channel allocation request signal, wherein
the link-channel allocating unit transmits the link-channel allocation signal to the wireless communication terminal using the downlink handover control channel determined by the channel determining unit.

13. The cell station according to claim 12, wherein the channel determining unit determines the downlink handover control channel by a random number calculation based on number information concerning the number of neighboring stations which is transmitted from the wireless communication terminal.

14. The cell station according to claim 11, comprising
a link-channel activating unit that activates a link channel allocated to the wireless communication terminal upon determining that the cell station is a handover-destination cell station based on determination information concerning the handover-destination cell station which is transmitted from the wireless communication terminal.

15. The cell station according to claim 11, wherein the communication channels are subchannels to be used for OFDMA in which a frequency band to be used for communication is divided into a plurality of subchannels each including a plurality of subcarriers.

16. The cell station according to claim 15, wherein the link-channel allocating unit allocates any one of subchannels to be used for traffic channels as a dedicated control channel dedicated for the wireless communication terminal, and transmits a link-channel allocation signal including allocation information concerning the dedicated control channel.

17. A method for TDMA wireless communication with use of one or more communication channels among at least one of a plurality of cell stations and a wireless communication terminal, the method comprising:
a link-channel-allocation requesting step of the wireless communication terminal transmitting a link-channel allocation request signal upon handover without specifying a destination cell station, using a handover control channel which is included in the communication channels, used for transmitting control information concerning handover, and has a unique channel number in a wireless communication system; and
a link-channel allocating step of the one of the cell stations transmitting, to the wireless communication terminal, a link-channel allocation signal including link-channel allocation information using the handover control channel upon receiving the link-channel allocation request signal.
